(19) United States
(12) Patent Application Publication
(10) Pub. No.: US 2012/0238343 A1
(43) Pub. Date: Sep. 20, 2012

(54) Electronic Roulette Game with Multiple Wheels

(76) Inventors: Rick Perrone, Darien, CT (US); Roger Kidneigh, Las Vegas, NV (US)

(21) Appl. No.: 13/115,234

(22) Filed: May 25, 2011

Related U.S. Application Data
(60) Provisional application No. 61/454,324, filed on Mar. 18, 2011.
(60) Provisional application No. 61/487,996, filed on May 19, 2011.

(51) Int. Cl. G06F 17/00; A63F 5/00

(52) U.S. Cl. 463/17; 273/274

(57) ABSTRACT

A method to implement a roulette game that uses five (or any other number) wheels. A player can make individual bets on each of the individual wheels at the player's discretion, and when the player is done allocating his or her individual bets then the player spins the five wheels. After the wheels stop spinning, all of the player's bets on the table are resolved based on whether the bet is a winner for that particular wheel. Chips and wheels can be color (or pattern) coded so that chips appear differently depending on which roulette wheel those chips are being bet on. Chips that match the color (or pattern) of one the roulette wheels are associated with that wheel, and thus only the results of that particular roulette wheel matter to the resolution of the bet for that chip.

### CROSS REFERENCE TO RELATED APPLICATIONS

This application claims benefit to U.S. provisional application 61/454,324, filed on Mar. 18, 2011, entitled, “Five Wheel Roulette” which is incorporated by reference in its entirety. This application also claims benefit to U.S. provisional application 61/487,996, filed on May 19, 2011, entitled, “5 Wheel Progressive Roulette Video Wagering Game”, which is also incorporated by reference herein in its entirety.

### BACKGROUND OF THE INVENTION

1. Field of the Invention

The present general inventive concept is directed to a method, apparatus, and computer readable storage medium directed to a lottery game that incorporates a roulette type of game in the form of casino, lottery, online, wireless and multiplayer game.

2. Description of the Related Art

Roulette is a popular casino game. One drawback of the game of roulette is that some players may consider the game “slow” as it takes some time for bets to be placed, a wheel to spin, and bets to be resolved.

Jarvis, U.S. Pat. No. 6,890,255, (which is incorporated by reference herein in its entirety) addresses this by allowing a player to bet on multiple wheels of roulette simultaneously. Jarvis displays the roulette wheels as vertical reels and offers the player different paylines to wager on based on these wheels.

However, what is needed is a more flexible system than Jarvis that permits the players more betting options and entertainment.

### SUMMARY OF THE INVENTION

It is an aspect of the present invention to provide an exciting method to play a roulette-type game.

The above aspects can be obtained by a method that includes (a) providing an input device and an output device; (b) executing, on a processing unit operationally connected to the input device and the output device, instructions to perform: (c) providing at least two roulette wheels; (d) displaying a playing field; (e) receiving a plurality of wagers from a player, wherein each wager is placed on a predicted outcome and also associated with one of the at least two roulette wheels; (f) spinning the at least two roulette wheels; and (g) resolving the plurality of wagers using an outcome for each of the at least two roulette wheels that was associated with each respective wager.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is flowchart illustrating an exemplary method of playing a wagering game with multiple roulette wheels, according to an embodiment;

FIG. 2 is a drawing of an exemplary output device of a layout of a wagering game, according to an embodiment;

FIG. 3 is a drawing of an exemplary output device of a layout after selecting a first wheel, according to an embodiment;

FIG. 4 is a drawing of an exemplary output device of a layout after selecting a second wheel, according to an embodiment;

FIG. 5 is a drawing of an exemplary output device of a layout after spinning all wheels, according to an embodiment;

FIG. 6 is a flowchart illustrating a method to resolve a poker wager using multiple wheels, according to an embodiment;

FIG. 7 is a flowchart illustrating a method to resolve a identical results wager using multiple wheels, according to an embodiment;

FIG. 8 is a flowchart illustrating a method to resolve a specific number wager using multiple wheels, according to an embodiment;

FIG. 9 is a flowchart illustrating a method of receiving bets on different wheels, according to an embodiment;

FIG. 10 is a flowchart illustrating an exemplary method of retaining certain bets on the layout, according to an embodiment; and

FIG. 11 is a block diagram illustrating hardware that can be used to implement the methods described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement an electronic roulette game using multiple wheels. The game of roulette is known in the art, for example see U.S. patent publication 2008/0146311 which is incorporated by reference herein in its entirety for all purposes.

A player can play the game electronically, for example on a video stand-alone terminal, a networked video terminal, in a multi-player format, on a home computer (or portable wireless device) running an online-casino, or any other version which can perform methods described herein.

The player can play roulette on five (or any other number) of wheels. The player can place bets on each wheel, the bets on one wheel do not have to be identical to bets placed other wheels. When the player is done placing all bets the player can initiate a simultaneous spin (activation) of all five wheels. When all wheels stop spinning, each wheel will display a random result (one randomly selected number out of all of the numbers on the roulette wheel), and all wagers are resolved and winning wagers are paid based on a respective payout and losing wagers are taken.

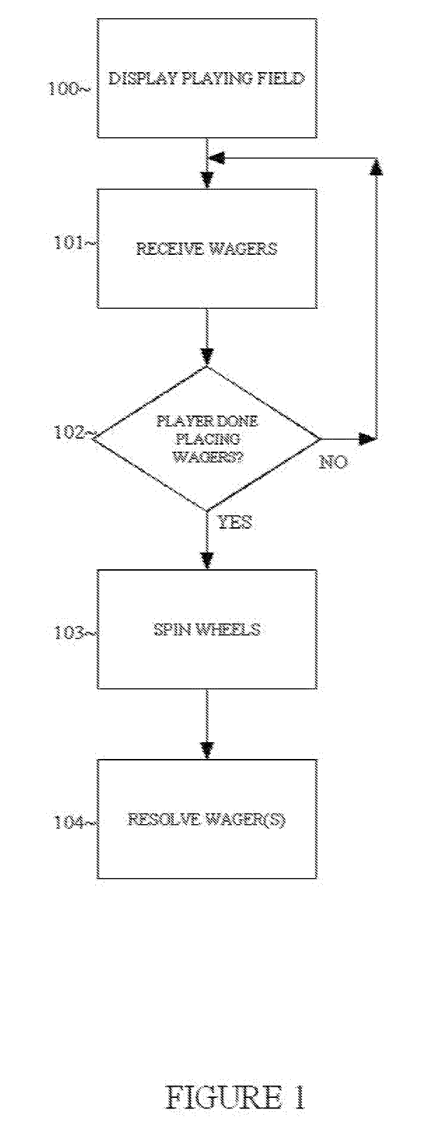

FIG. 1 is a flowchart illustrating an exemplary method of playing a wagering game with multiple roulette wheels, according to an embodiment.

In operation 100, the playing field (also known as “layout”) is displayed. The playing field can be the area where the player can place bets, for example the layout on roulette where players can place their wagers (in the form of real or virtual chips).

From operation 100, the method proceeds to operation 101, which receives wagers from the players. The players can indicate which particular wheel (out of the at least two wheels) the player wishes to place bets on (for example by touching or clicking an icon representing the particular wheel). The player can then touch individual bets on the playing field to indicate the player's desire to place bets on those individual bets. For example, the player can touch a particular icon indicating a particular denomination bet (e.g., $5 chip) and then touch a desired individual bet to bet on (e.g., odd, even, particular numbers, red, black, etc.) Thus, each wager (also referred to as “bet”) placed has at least these characteristics associated with it: the particular wheel bet on (e.g., first wheel, red wheel, etc), the amount, and the particular bet. Wheels can be uniquely numbered (e.g., from one to five) or uniquely colored (e.g., a red wheel, orange wheel, yellow wheel, blue wheel, and violet wheel). A wager placed typically deducts that amount from the player's credit meter.

The player is also allowed to select how many wheels the player wishes to use. The player can be offered up to a certain amount of wheels (e.g., five), and the player is free to play five wheels simultaneously or any lesser number of wheels, at the player's choice.

From operation 101, the method proceeds to operation 102, which checks if the player is done placing wagers. If the player clicks a “spin” button (which lets the system know that the player is done placing bets and the player wants to initiate all of the wheels to spin) then the method proceeds to operation 103.

If the player is still placing bets (because the player did not press the spin button or other button indicating a desire to complete betting), the method returns to operation 101, wherein the player can continue placing bets (on any wheel the player chooses).

From operation 102, if the player has pressed the “spin” button, then the method proceeds to operation 103, which spins all of the wheels. The five (or other number) roulette wheels all spin simultaneously and stop at their own random result (which is a number on the wheel).

From operation 103, the method proceeds to operation 104, which resolves the wager(s) the player placed. A wager placed on particular bets which meets a winning condition for the wheel associated with the wager wins a respective payout while if the wager does not meet the respective winning condition then the wager loses. Respective payouts are added to the player's credit meter while losing wagers do not add to the player's credit meter. There is typically no limit to the number of individual wagers a player can place before spinning the wheels.

Once all of the wagers have been resolved, the player is free to begin the method again and make brand new wagers (assuming the player still has credits left). In one embodiment, all wagers placed are now cleared on the layout so new wagers can be placed. In another embodiment, see below, some wagers may be retained on the layout. The player is also free to fund his or her play (increase the credit meter) by buying in for real money (e.g., inserting cash or a cashless voucher, using an e-payment mechanism (e.g., credit card, electronic fund transfer account, etc.), or any other way to fund wagering activity.

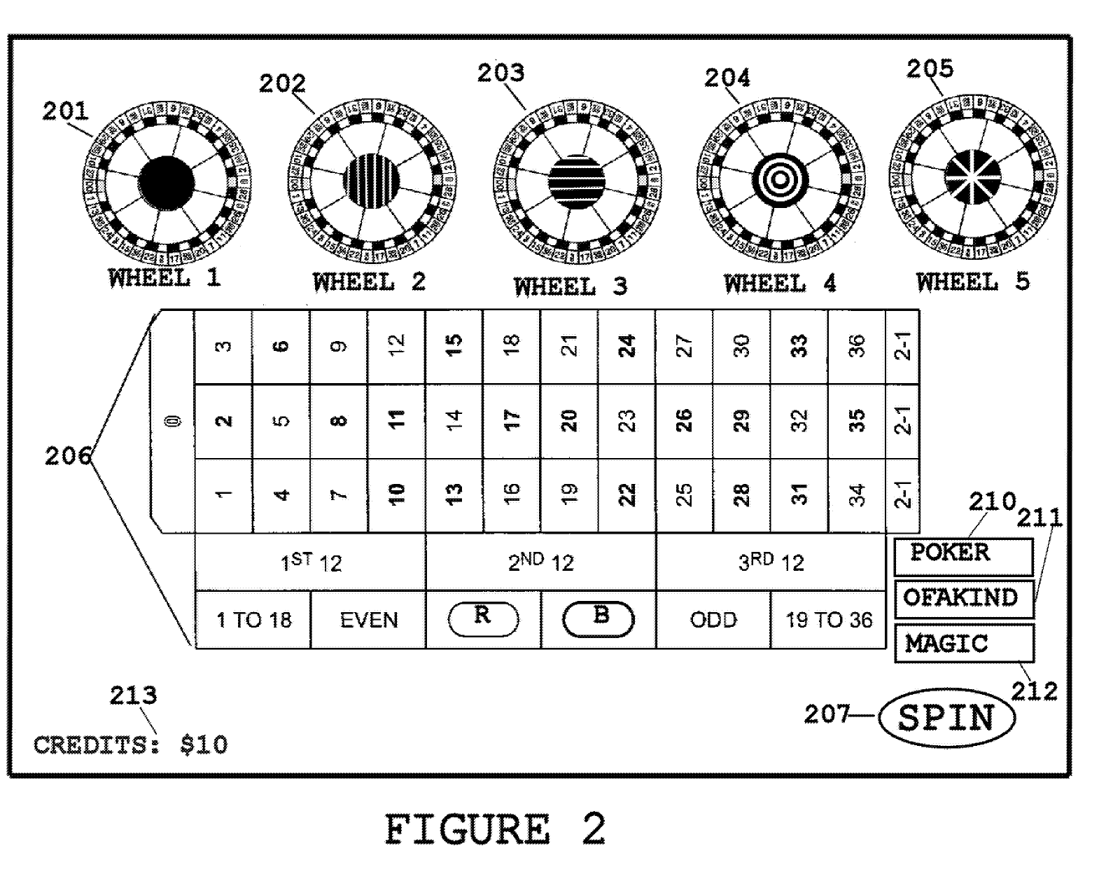

FIG. 2 is a drawing of an exemplary output device of a layout of a wagering game, according to an embodiment.

A playing field 206 shows numerous different individual roulette wagers which are known in the art. The bet marked a′ is for red (the number the ball lands on is red) and ‘B’ is for black (the number the ball lands on is black). A first wheel 201, a second wheel 202, a third wheel 203, a fourth wheel 204, and a fifth wheel 205. By touching (using a touch-screen) or clicking (using a mouse), graphical user interface (GUI) or other input devices such as a keyboard infrared or other devices/techniques to activate a particular wheel, the wheel then becomes “selected” and all additional wagers placed on the playing field will be associated with the selected (particular wheel). When the player is done placing his or her wagers the player can press (e.g., touch, click, etc.) the “spin” button 207 which starts all of wheels spinning (which will eventually stop spinning after a short spin (e.g., 10 seconds or other duration).

A credit meter (on the bottom left) shows the player starting with $10. While not pictured, a portion of the output device can allow the player to select a denomination of a chip to bet (e.g., $1, $2, $5, $25, $100, etc.)

The player can also place his chips on a poker 210 wager, an of a kind 211 wager and a magic chip 212 wager. These wagers will be discussed below in more detail.

A standard American or European (00 and 0) roulette pay table can be used, for example the one illustrated below in Table I. The example below illustrates a European single 0 table.

TABLE I

| | | HIT | PAY | |
|---|---|---|---|---|
| | | FREQ | ODDS | |
| PATTERN | PROBABILITY | 1 IN | TO 1 | $1 PAYS |
| One Number | 0.027027027 | 37.00 | 35 | $35.00 |
| Two Numbers | 0.054054054 | 18.50 | 17 | $17.00 |
| Three Numbers | 0.081081081 | 12.33 | 11 | $11.00 |
| Four Numbers | 0.108108108 | 9.25 | 8 | $8.00 |
| Five Numbers | 0.135135135 | 7.40 | 6 | $6.00 |
| Six Numbers | 0.162162162 | 6.17 | 5 | $5.00 |
| Twelve Numbers | 0.324324324 | 3.08 | 2 | $2.00 |
| Eighteen Numbers | 0.486486486 | 2.06 | 1 | $1.00 |

All standard roulette bets can be made, for example straight up bets, split bets, street bets, corner bets, six line bets, trio bets, basket bets, top line bets, 1 to 18, 19 to 36, red or black, even or odd, dozen bets, column bets, etc. The player would make any desired bet by placing his or her chip in the appropriate position on the virtual table layout in the same manner as is done in a real physical roulette game.

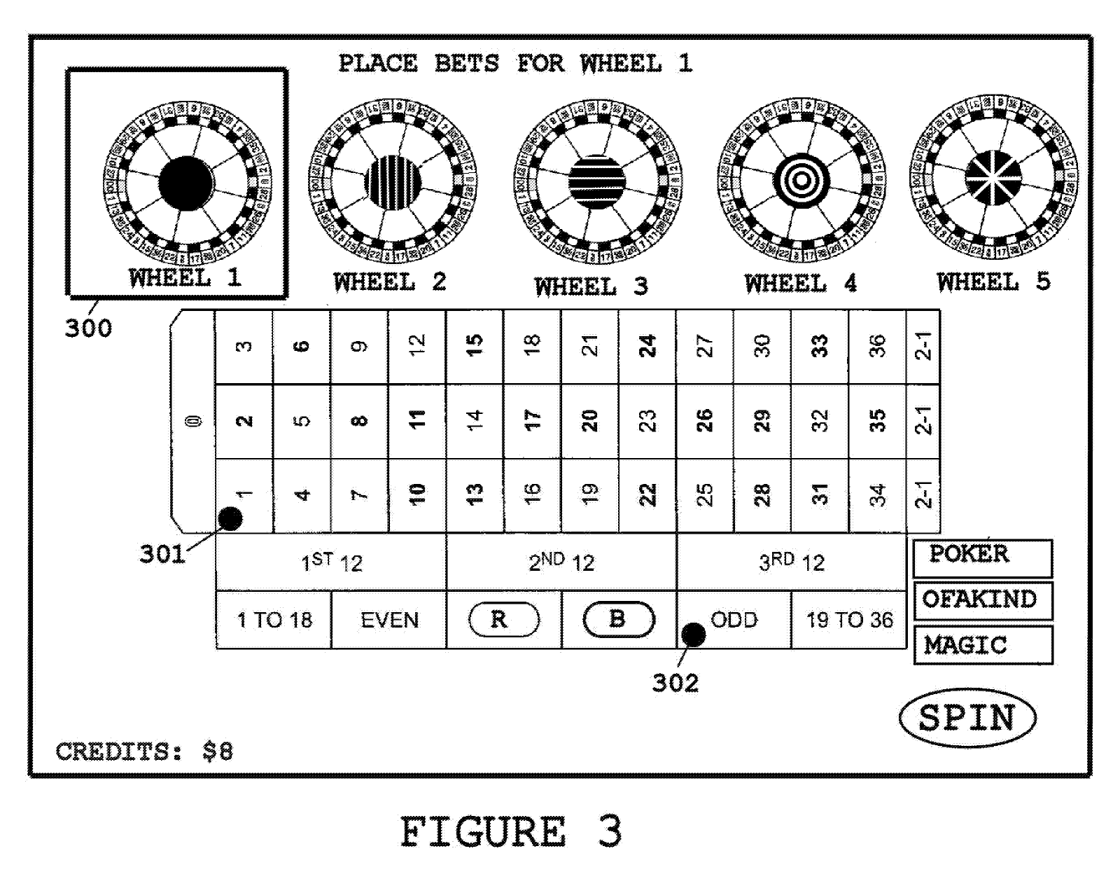

FIG. 3 is a drawing of an exemplary output device of a layout after selecting a first wheel, according to an embodiment.

The player selects the first wheel 201 by touching it (or clicking it, etc.) upon which the first wheel becomes highlighted 300. Now, all wagers placed on the playing field are placed on the result of the first wheel (when it spins to a result). The player places a $1 wager (the player can also choose the denomination) wager on the number 1 301 (which pays if the result of the wheel is the number 1 otherwise it loses) and places another $1 wager on ‘odd’ 302 (which pays if the result of the wheel is odd otherwise it loses). The player's credit meter drops to $8 (from $10) because $2 in wagers have been placed on the table. Note that the player's bets 301 302 are in solid black which matches the pattern of wheel 1 (which is the currently selected wheel). Note that the center of each of the wheels have a pattern which is used for chips placed for that wheel.

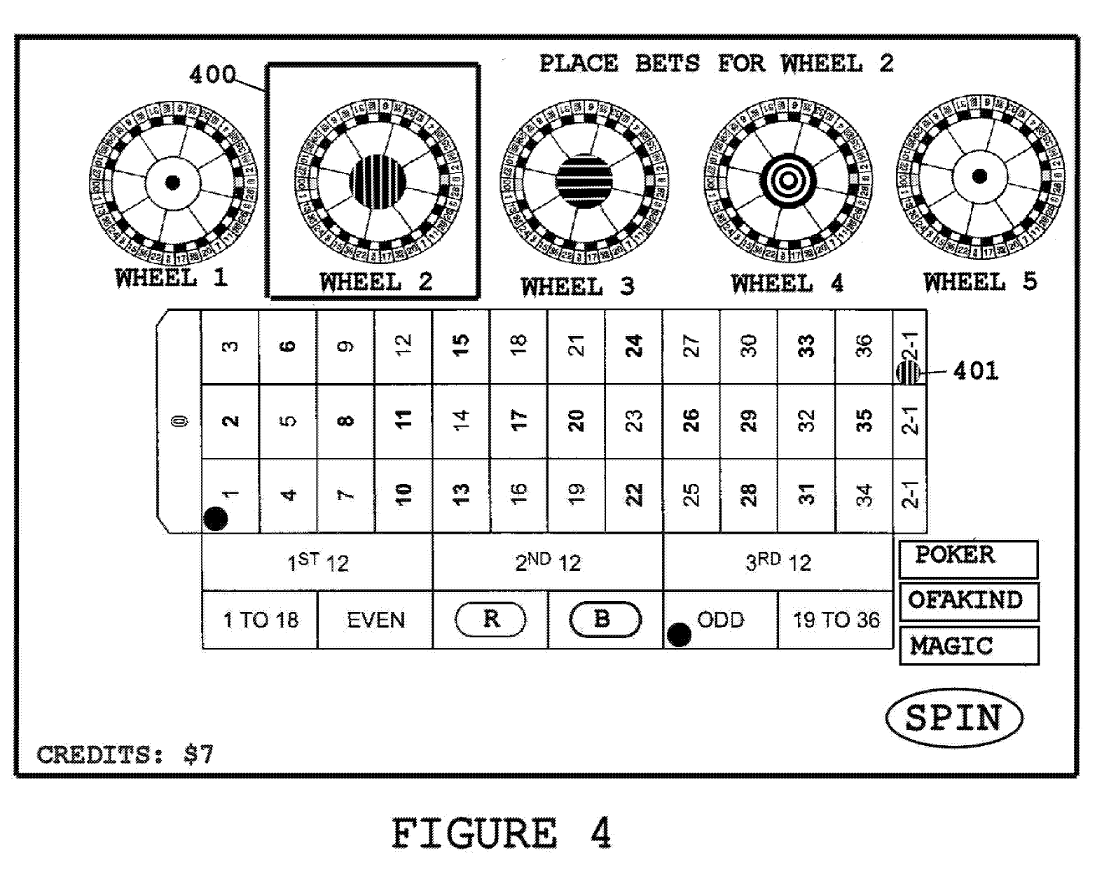

FIG. 4 is a drawing of an exemplary output device of a layout after selecting a second wheel, according to an embodiment.

The player then selects (by touching or clicking, etc.) the second wheel which is then highlighted 400. The player then makes a third wager 401 on the third column (this wager wins (2:1) if the final number is a 36, 33, 30, 27, 24, 21, 18, 15, 12, 9, 6, 3) and loses on all other numbers. The third wager is associated with the second wheel (pays only based on the second wheel while the other wheels are irrelevant). The player's credit meter drops down to $7.

Note that the color (or appearance) of the third wager 401 is different than the first two wagers 301, 302, so that the player can differentiate which chips on the playing field are associated (win or lose) based on which wheel (when spinned to a result). Thus displayed wheels can also be displayed in the same color or style as their corresponding chips so that the player at first glance can instantly see which individual wagers placed are keyed which wheels. Note that the pattern of the third wager 401 matches the pattern of the second wheel (the currently selected wheel). Thus, for example, chips (wagers) placed on individual bets for the first wheel are displayed in solid black while chips (wagers) placed on individual bets for the second wheel are displayed in black with white stripes. Note that each of the five wheels shows its own design (or in another embodiment, color) that matches the chips bet on that wheel. Thus, by looking at the playing field it is easy to discern which chips (by their appearance) are associated with which wheels.

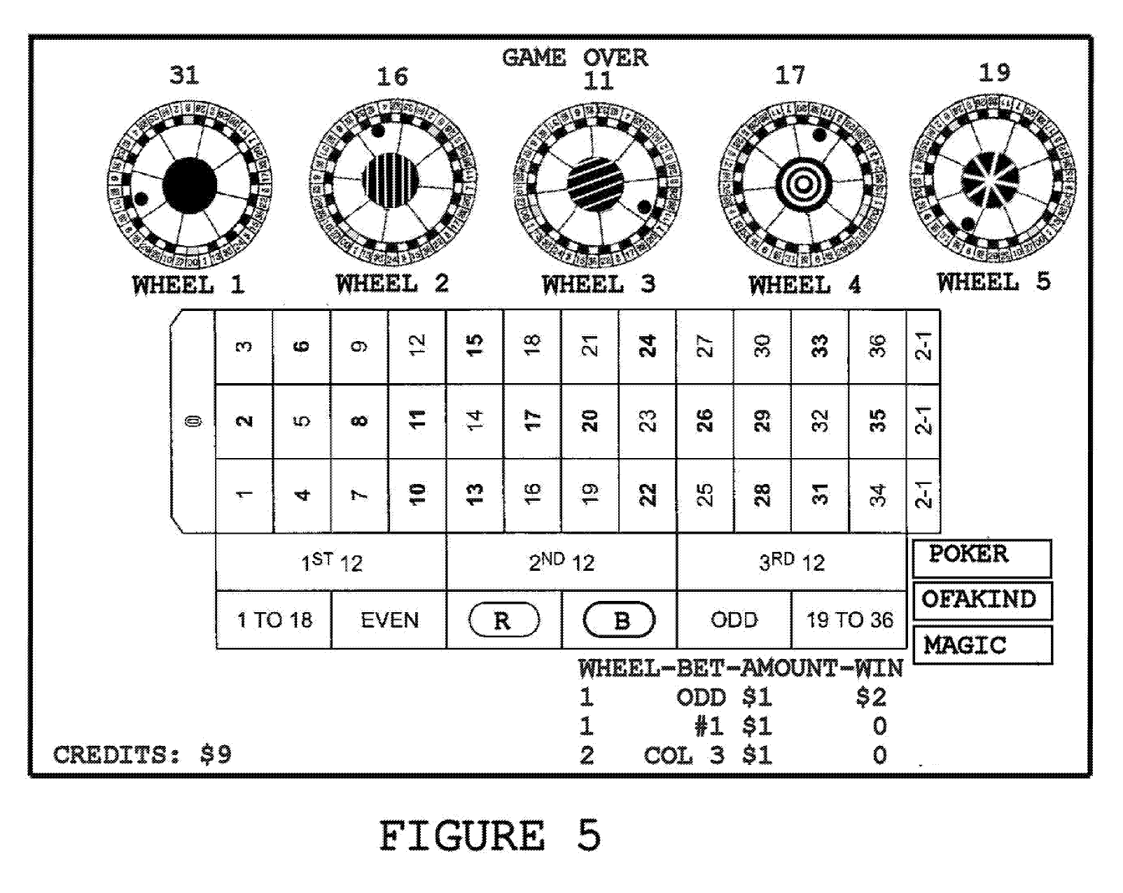

FIG. 5 is a drawing of an exemplary output device of a layout after spinning all wheels, according to an embodiment.

The wheels have stopped spinning and their results are shown (each wheel's result is indicated by the ball being stopped above/below the result (number). Wheel 1 has stopped on 31, wheel 2 has stopped on 16, wheel 3 has stopped on 11, wheel 4 has stopped on 17, and wheel 5 has stopped on 19.

On the bottom right is a display showing all of the player's bets and resolutions. The player won one bet (the odd $1 bet on wheel 1) and lost the other two bets (the bet on #1 on wheel 1, and the column 3 bet on wheel 3). Thus, the player wins even money on the first bet and loses the other bets, for a total payout of $2 or a net loss of $1 (since the player bet $3 originally).

The player can now begin a new game if the payer desires and start all over again. The player can also deposit more money or cash out the players credits (in the form of cash, a cashless voucher, or a credit to an electronic banking account, or any other payment method).

The player can also place a poker wager on the result of the five different wheel spins. If all of the five numbers resulting from each of the different five wheel spins form a poker hand, then the poker wager (if made) wins a payout, otherwise the poker wager loses.

Table II below illustrates one example paytable for a poker wager, of course it is noted that this is merely one example and many other possible payout structures could be used. The numbers to form the poker hand are taken from each of the five roulette wheels that were simultaneously spun.

TABLE II

| | | | PAYOFF | |
|---|---|---|---|---|
| HAND | PROBABILITY | FREQ | (X TO 1) | CONTRIB |
| STRAIGHT | 0.0057106634% | 17,511 | 2,500 | 0.14282 |
| FULL HOUSE | 0.0192619524% | 5,192 | 1,000 | 0.19281 |
| 2 PAIRS | 1.0180555459% | 98 | 20 | 0.21379 |
| FLUSH | 5.2247378961% | 19 | 5 | 0.31348 |
| NOTHING | 93.7322339422% | 1.07 | 0 | 0 |

Note that a straight means five consecutive numbers, for example, 5, 6, 7, 8, 9. A full house means a three of a kind and a pair (e.g., 10, 10, 10, 4, 4). 2 Pairs means two sets of matching numbers (with a fifth number not matching), for example, 2, 2, 5, 5, 9. A flush means all numbers of the same color (e.g., red or black). Nothing means none of these patterns.

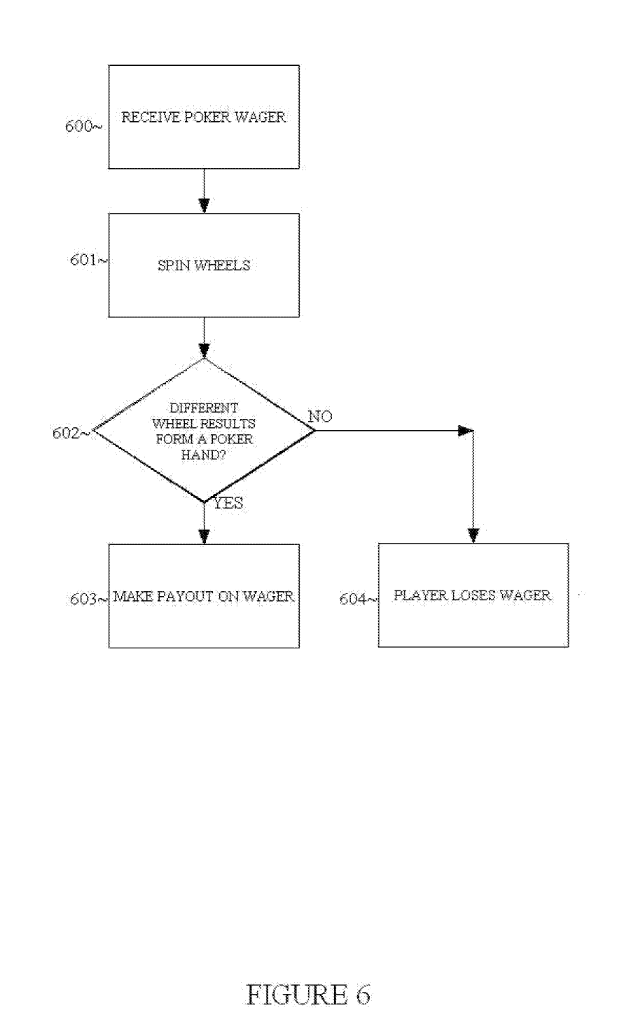

FIG. 6 is a flowchart illustrating a method to resolve a poker wager using multiple wheels, according to an embodiment.

The method begins with operation 600, which receives the poker wager. This can be done by the player placing a chip in the poker wager bet 210. Since (in this example) the poker wager is a bet across a minimum of 5 wheels (although other numbers of wheels can be used as well), it does not matter which particular wheel is currently selected before the poker wager is placed.

From operation 600, the method proceeds to operation 601, wherein the player spins all five wheels. This is done as described herein.

From operation 601, the method proceeds to operation 602, which determines whether the different results from all five wheels form a paying poker hand (using a table such as Table II).

If the results of the five wheels do not form a paying poker hand, then the method proceeds to operation 604, wherein the player loses the poker wager (the poker wager is taken but not paid anything).

If the results of the five wheels do form a paying poker hand, then the method proceeds to operation 603, which makes a payout on the poker wager. The payout is determined using a pay table (such as that illustrated in Table II).

In a further manner of betting, an “of a kind” wager can be placed by placing a bet in the “of a kind” bet 211 area. The of a kind wager is betting that three or more of a number (any number) will result from the spins of the five wheels. The player does not select a number for the of a kind wager.

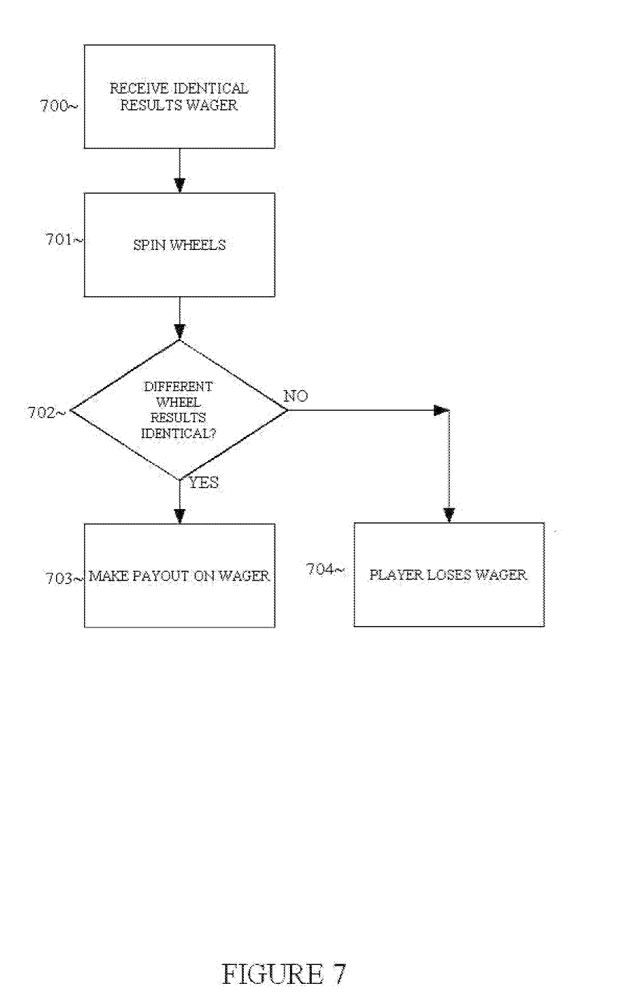

FIG. 7 is a flowchart illustrating a method to resolve a identical results wager using multiple wheels, according to an embodiment.

In operation 700, the player places his/her chip for the of a kind wager in the respective betting area. Like the poker wager, it does not matter which wheel is currently selected by the player to bet on because the of a kind wager can use a plurality of wheels (e.g., three or more) to resolve the bet. Then, in operation 701 the wheels spin. In operation 702, it is determined whether the player has a winning bet or not using the five different wheel results.

If there are three or more (or in another embodiment, two or more) appearances of a same number (any number), then the method proceeds to operation 703, which pays the player using a pay table such as that illustrated in Table III.

If there are not three or more (or in another embodiment, two or more) appearances of a same number (any number), then the method proceeds to operation 704, wherein the player does not receive a payout and loses the of a kind wager.

TABLE III

| | | | PAYOFF | |
|---|---|---|---|---|
| HAND | PROBABILITY | FREQ | (X TO 1) | CONTRIB |
| 5 OF A KIND | 0.0000533572% | 1,874,161 | 500,000 | 0.26679 |
| 4 OF A KIND | 0.0096042976% | 10,412 | 2,500 | 0.24020 |
| 3 OF A KIND | 0.6915094274% | 145 | 5 | 0.35267 |
| NOTHING | 99.2988329178% | 1.01 | 0 | 0 |

For example, if the player places a $1 of a kind wager and the player receives on the five wheels: 4, 8, 34, 21, 6, then the players of a kind wager would lose because there are not three or more of the same number. As another example, if the player receives on the five wheels: 5, 3, 32, 3, 3, then since the player has received three 3's the player wins a payout of $5 (5 to 1) using Table III.

In yet a further wager, the player can make a “magic chip” wager using the “magic chip” bet 212. This bet is similar to the “of a kind” wager described above but the player actually selects a particular number that the player predicts (hopes) will come up on the wheels. For example, the player can make this bet and would also pick a number (e.g., 23) that the player hopes will appear on all of the wheels after the spin so the player would get the maximum award.

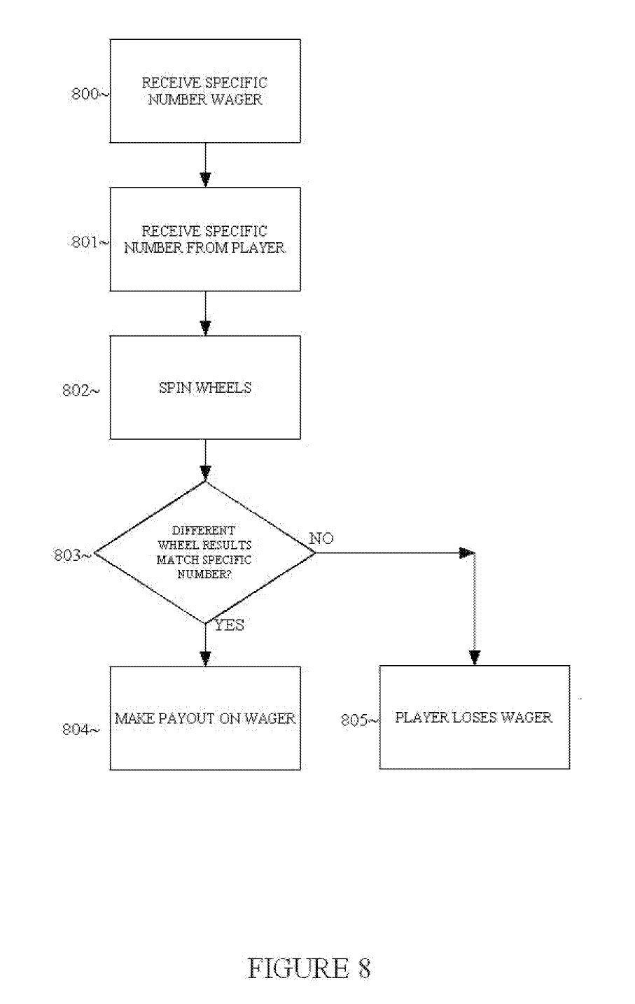

FIG. 8 is a flowchart illustrating a method to resolve a specific number wager using multiple wheels, according to an embodiment.

In operation 800, the player places a chip on the magic chip bet. Like the poker wager and the of a kind wager, it does not matter which roulette wheel the player has currently selected. The method proceeds to operation 801, wherein the player is prompted to enter a specific roulette number (a number that appears on the roulette wheel, typically 1 to 36, 00 and 0), and the player would enter his/her number. From operation 801, the method proceeds to operation 802, wherein the wheels spin as described herein.

From operation 802, the method proceeds to operation 803, which determines whether the different wheel results contain three or more (or in another embodiment 2 or more or in another embodiment just one or more) of the specific roulette number. If not, then the method proceeds to operation 805, wherein the player loses the magic chip wager and receives no payout.

If a predetermined frequency (based on a current payout table) of the specific number does appear on the roulette wheels, then the method proceeds to operation 804, wherein the player's magic chip bet wins and the player is paid an award based on a paytable (such as that illustrated in Table IV).

TABLE IV

| | | | PAYOFF | |
|---|---|---|---|---|
| HAND | PROBABILITY | FREQ | (X TO 1) | CONTRIB |
| 5 OF A | 0.0000014421% | 69,343,957 | 20,000,000 | 0.28842 |
| KIND | | | | |
| 4 OF A | 0.0002595756% | 385,244 | 100,000 | 0.25958 |
| KIND | | | | |
| 3 OF A | 0.0186894440% | 5,351 | 1,500 | 0.28053 |
| KIND | | | | |
| NOTHING | 99.9810495383% | 1 | 0 | 0 |

For example, a player makes a $1 magic chip wager and selected the number 11 as the specific roulette number. The five wheels spin and the results are: 4, 11, 4, 4, 11. Using Table IV, the player's magic chip wager would lose because the player's specific number (11) did not appear at least three times (although in another embodiment a paytable can be used that pays an award for a frequency of two of the specific number or even one of the specific number).

As another example, suppose a player makes a $1 magic chip wager and selects the number 10. The five wheels spin and the results are 10, 4, 10, 3, 10. Since the player has achieved three 10's (the number entered by the player), according to Table IV the player receives a payout of $1,500 (1,500 to 1).

Each of the poker wager, of a kind wager, and magic chip wager, can also incorporate a progressive payout as well. If a top payout is reached, instead of paying a fixed amount, the award that is paid is an entire jackpot pool (which can be funded over time by allocating a small portion of each of the bets placed).

One feature of the inventive concept described herein is the ability of a player to place different bets on different wheels. The player is also able to (at a glance) look at the playing field and know immediately which bets are placed for which wheels (because of the color/pattern coding).

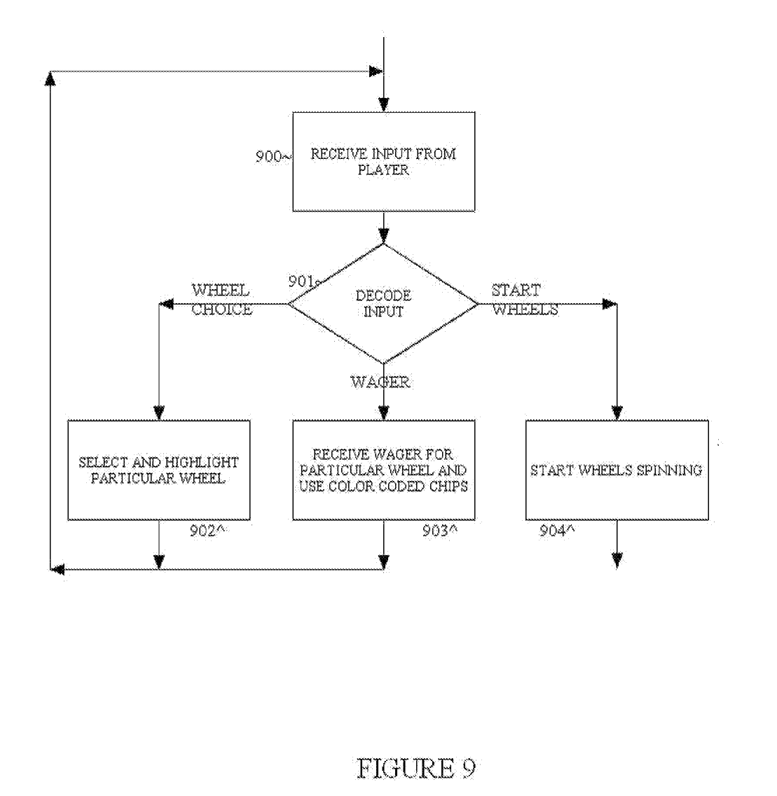

FIG. 9 is a flowchart illustrating a method of receiving bets on different wheels, according to an embodiment. FIG. 9 can be implemented during operation 101 of FIG. 1.

The method begins with operation 900, which receives an input from a player. An input can be a touch (if using a touch-screen), a mouse click (if using a mouse), a keypress or button press, or any other input device or method, etc. Basically, the input is some action that the player has entered that the computer implementing the process now must take action based on.

From operation 900, the method proceeds to operation 901, which decodes the input received in operation 900.

If the input in operation 900 is a wheel choice (e.g., the player has selected (clicked, touched, etc., a particular roulette wheel) then the method proceeds to operation 902. In operation 902, the selected wheel is now highlighted visually (this can be done in many ways such as drawing a box around the highlighted wheel or by dimming out the other four wheels), and is also stored electronically. Future wagers (chips placed on betting areas) will now be keyed (associated) with the selected wheel and only the selected wheel is what is used to resolve these bets (chips). The method can then return to operation 900 to continue decoding input from the player.

If the input in operation 900 is a wager (the player is placing a wager), then the method proceeds to operation 903 which receives a wager. The wager has three components: the amount, the current selected wheel (selection in operation 902), and the type of bet (straight up, red/black, etc.) All of these parameters are stored with the bet so the system can properly resolve the bet later (after the wheels are spun).

The system will display the five wheels in a different appearance (pattern or color). Chips placed in operation 903 will also have the same appearance of the currently selected wheel. For example, if a first wheel is associated with the color red and the second wheel is associated with the color orange, then chips placed on bets associated (based on) the first wheel will appear in red while chips placed on bets associated (based on) the second wheel will appear in orange. Each individual wheel can have its own pattern (or color) so at a glance, the player can see which bets are associated with which wheels. Players are free to remove (cancel) bets they have placed at any point up until the wheels are spin. Once a wager is placed in operation 903, the method returns to operation 900 so additional input can be received from the player.

If the input in operation 900 indicates to start the wheels spinning (e.g., pressing the spin button), then the wheels will start to spin (and stop) and then all of the wagers placed can be resolved based on the output (result) of the wheels. The five (or however many wheels are being used) would typically spin simultaneously, although in another embodiment, they can spin sequentially or a part-simultaneous and part-sequentially.

Thus, using the methods described herein, the player can place different bets on different wheels, entirely at the player's choice. The player has full freedom of choice of which wagers to place and which wheels those wagers will be associated with. The player is not forced to place a particular wager across all of the wheels. For example, the player can make a straight up number bet on number 9 on wheel 1 (but not the other wheels), while the player bets red on wheel 2 (but not the other wheels), while the player bets odd on wheel 3 (but not the other wheels), etc. The player has full choice to choose which bets to make and associate those bets with which wheels the player chooses.

It is also noted that other inputs can be received by the player than those listed in FIG. 9, for example, cash out, cash in, cancel bet, etc. These inputs can be addressed by the system as known in the art and need not be discussed in detail herein.

In one embodiment, after a spin and after all bets are resolved (in operation 104), all bets on the layout can be automatically removed so the player can make brand new bets. In a further embodiment, after wagers are resolved (in operation 104) some or all bets that the player has placed can still be retained on the layout for future spins. For example, the player can designate that all wagers placed on a particular wheel (e.g., wheel 1) can remain on the layout after the spin while bets for all other wheels (and bets such as poker, of a kind, and magic chip that are not associated with a wheel) are automatically removed. Thus, for example, a player can place his lucky numbers on wheel 1 while making arbitrary bets on the other wheels. The player can designate (using the GUI) that the player wishes all bets associated with wheel 1 to remain on the layout after the game is over. Thus, after a spin and all bets are resolved, the bets the player made on wheel 1 remain while all bets on all the other wheels are automatically removed. In this manner, the player does not have to repeatedly make the same wager(s) that the player knows he or she will make over and over again.

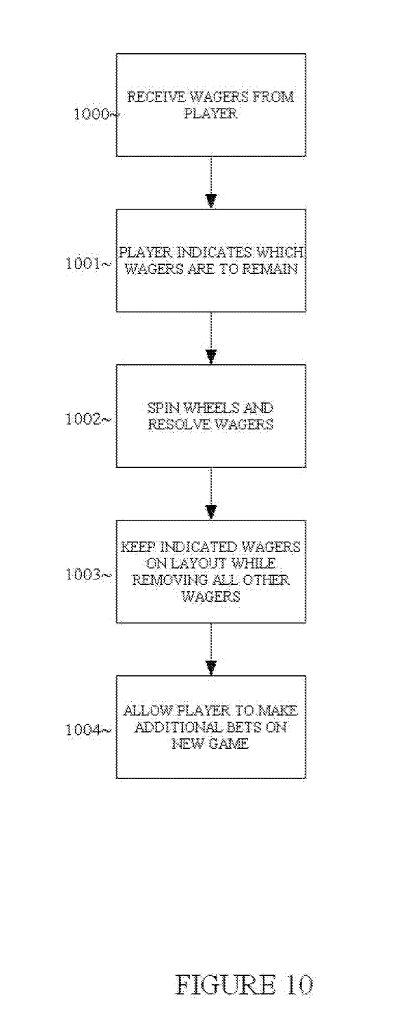

FIG. 10 is a flowchart illustrating an exemplary method of retaining certain bets on the layout, according to an embodiment;

The method begins with operation 1000, which receives wagers (also referred to herein as bets) from the player as described herein.

From operation 1000, the method proceeds to operation 1001, wherein the player indicates which wagers placed are to remain after the game is over (the “indicated wagers”). This can be done in a number of ways. For example, the user can use a graphical user interface (GUI) or other input method to select a particular wheel or wheels wherein all wagers placed on those particular wheel(s) will remain. Thus, after the spin, only those wagers on the particular wheel(s) selected by the player will remain while all others will automatically be removed. This can be done in two ways. In a first embodiment, all wagers on the selected particular wheel whether placed before or after the selection of the particular wheel will remain after the game ends (while other non-indicated bets are removed). In a second embodiment, all wagers currently placed on the selected particular wheel will remain after the game ends (while other non-indicated bets are removed) but bets placed after the selection of the wheel will not remain. Thus, in the first embodiment, wagers on a particular wheel (or wheels) are always indicated wagers which will remain, regardless of when placed. In the second embodiment, the computer automatically gives all wagers currently placed on an particular wheel selected by the player status as an indicated wager, but bets placed afterwards are not considered indicated wagers (unless the player actively uses the GUI to give them indicated status).

Instead of selecting an entire wheel, the user can select individual wagers (by pointing/touching/clicking the chips on the layout) on the layout to indicate those wagers will remain after all wagers are resolved.

From operation 1001, the method proceeds to operation 1002, which spins the wheels and resolves all placed wagers. This is done as described herein.

From operation 1002, the method proceeds to operation 1003, which maintains indicated wagers on the layout while removing all other wagers from the layout. If a particular wheel(s) was selected by the player as only containing indicated wagers, then all wagers on the particular wheel(s) are maintained (regardless of when placed) while all other wagers are automatically removed.

From operation 1003, the method proceeds to operation 1004, wherein the player is now allowed to make new bets (while keeping the indicated wagers on the layout) and spin the wheels anew.

In a further embodiment, “racetrack” wagers can be placed in roulette in which after each spin, the bet changes to a different number (or pattern). For example, a player can place a wager on straight up number 1. After a spin (win or lose), the player then places a new wager on straight up number 2. After a spin (win or lose), the player then places a new wager on straight up number 3, and so on. Upon reaching number 36, the player can begin again at number 1 (or 0 or 00).

Racetrack wagers can also be placed automatically, wherein after each spin, the computer can automatically follow the pattern and place the next wager accordingly. In an embodiment, a racetrack wager can be designated to be placed automatically on a chosen wheel chosen by the player. For example, the player can make a racetrack bet on wheel 5 and indicate to the computer (using the GUI or another input method) that this is a racetrack bet. Thus, after each spin, the computer would automatically place a new wager on wheel 5 to maintain the racetrack wager. A wager that automatically changes according to a predefined sequence can be considered a “moving wager” of which a “racetrack wager” is merely one example.

Thus, the game can be configured to have a moving wager on one wheel while all of the other wheels contain static (non-moving) wagers which are placed by the player.

In a further embodiment, a “universal chip” can be selected by the player which places a wager chosen by the user on all (or a selected subset of more than one) wheels. For example, the player can select a universal chip (for a denomination such as $1) and bet on even which is applied to all five wheels. Thus, the player now has a $1 even bet on all five wheels (for a total of $5 bet). For each individual wheel result, it the result is even then the player wins the $1 bet and if the result is not even then the player loses the $1 bet (thus the player can lose a maximum of $5 and win a maximum of $5). This embodiment makes betting easier for the player because the player can bet on multiple wheels even though the player only had to place one individual bet. Universal chips can be given their own color/pattern or other indication to indicate on the layout they apply to more than one wheel.

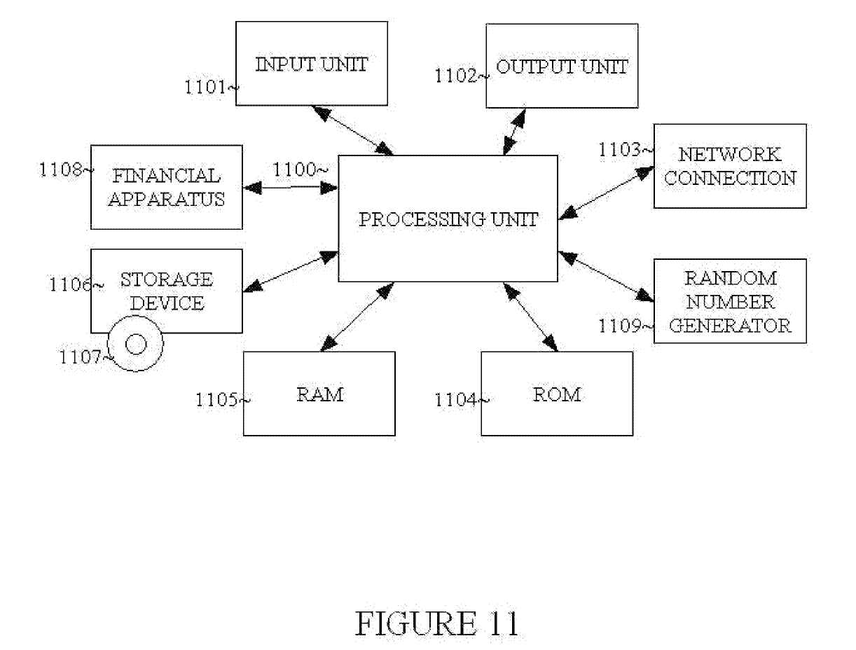

FIG. 11 is a block diagram illustrating hardware that can be used to implement the methods described herein, according to an embodiment.

The hardware shown herein can be used for the game server and a terminal, a standalone video-gaming apparatus, and any other digital computer or wired or wireless computing device used to play the game described herein.

A processing unit 1100 can be a microprocessor and any associated structure (e.g., bus, cache, etc.) The processing unit 1100 can be connected to an input unit (e.g., keyboard, buttons, touch-screen display, etc.) and an output unit (e.g., touch-screen display, speakers, LCD display, etc.) The processing unit can also be connected to a network connection 1103 which can connect to any type of computer communications network (e.g., DSL, LAN, WAN, WiFi, Internet, etc.) The processing unit 1100 can also be connected to a ROM 1104 and a RAM 1105. The processing unit 1100 can also be connected to a storage device 1006 (e.g., hard disk, CD-ROM drive, DVD-drive, EPROM, etc.) which can read a computer readable storage medium 1107 (e.g., CD-ROM, DVD, flash memory, etc.) The storage device 1106 can be used to store a program to control a computer to perform any of the digital methods described herein. The processing unit 1100 is also connected to an optional financial apparatus 1108 which can accept payment from a player (e.g., cash, credit card, electronic payment, etc), and may also have functionality to credit wins back to the player (e.g., electronic deposit, cashless ticket, player's club account, etc.) In addition, the processing unit 1100 is connected to a random number generator 1109 which can be embodied in software, hardware, or a combination of both, which is used to generate random outcomes for spins and any other needed random number.

Any description of a component or embodiment herein also includes hardware, software, and configurations which already exist in the prior art and may be necessary to the operation of such component(s) or embodiment(s). Any feature described in this application can be combined with any feature or structure in U.S. Pat. No. 7,597,619 which is incorporated by reference in its entirety for all purposes.

As used herein, “bet” and “wager” can be used interchangeably.

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a wagering game, the method comprising:
providing an input device and an output device;
executing, on a processing unit operationally connected to the input device and the output device, instructions to perform:
providing at least two roulette wheels;
displaying a playing field;
receiving a plurality of wagers from a player, wherein each wager is placed on a predicted outcome and also associated by the player with one but not all of the at least two roulette wheels;
spinning the at least two roulette wheels; and
resolving the plurality of wagers using an outcome for each of the at least two roulette wheels that was associated with each respective wager.

2. The method as recited in claim 1, wherein each of the at least two roulette wheels has a unique appearance and a chip bet on the playing field matches a respective appearance of one of the at least two roulette wheels that the player associates with the chip.

3. The method as recited in claim 1, wherein there are five of the at least two roulette wheels.

4. The method as recited in claim 1, further comprising offering the player a poker wager which pays an award when results from each of the at least two roulette wheels form a poker hand.

5. The method as recited in claim 1, further comprising offering the player an of a kind wager which pays an award when results from each of the at least two roulette wheels form at least a predetermined frequency of a same number.

6. The method as recited in claim 1, further comprising offering the player a magic chip wager which receives a specific roulette number from the player, and which pays an award when results from each of the at least two roulette wheels form at least a predetermined frequency of the specific roulette number.

7. The method as recited in claim 1, wherein a number of the at least two roulette wheels is chosen by the player.

8. The method as recited in claim 1, wherein the player indicates a particular wheel out of the at least two roulette wheels, and after the resolving, all wagers placed on the particular wheel remain on the layout while all wagers not placed on the particular wheel are automatically removed from the layout.

9. The method as recited in claim 1, wherein during the receiving, the player places a universal chip on a predicted outcome and the universal chip is automatically associated with all of the at least two roulette wheels.

10. An apparatus to play a wagering game, the method comprising:
an input device;
an output device;
a processing unit operationally connected to the input device and the output device, the processing unit configured to execute instructions to perform:
displaying at least two roulette wheels;
displaying a playing field;
receiving a plurality of wagers from a player, wherein each wager is placed on a predicted outcome and also associated by the player with one but not all of the at least two roulette wheels;
spinning the at least two roulette wheels; and
resolving the plurality of wagers using an outcome for each of the at least two roulette wheels that was associated with each respective wager.

11. The apparatus as recited in claim 10, wherein each of the at least two roulette wheels has a unique appearance and a chip bet on the playing field matches a respective appearance of one of the at least two roulette wheels that the player associates with the chip.

12. The apparatus as recited in claim 10, wherein there are five of the at least two roulette wheels.

13. The apparatus as recited in claim 10, further comprising offering the player a poker wager which pays an award when results from each of the at least two roulette wheels form a poker hand.

14. The apparatus as recited in claim 10, further comprising offering the player an of a kind wager which pays an award when results from each of the at least two roulette wheels form at least a predetermined frequency of a same number.

15. The apparatus as recited in claim 10, further comprising offering the player a magic chip wager which receives a specific roulette number from the player, and which pays an award when results from each of the at least two roulette wheels form at least a predetermined frequency of the specific roulette number.

16. The apparatus as recited in claim 10, wherein a number of the at least two roulette wheels is chosen by the player.

17. The apparatus as recited in claim 10 wherein the player indicates a particular wheel out of the at least two roulette wheels, and after the resolving, all wagers placed on the particular wheel remain on the layout while all wagers not placed on the particular wheel are automatically removed from the layout.

18. The apparatus as recited in claim 10, wherein during the receiving, the player places a universal chip on a predicted outcome and the universal chip is automatically associated with all of the at least two roulette wheels.

19. An apparatus to play a wagering game, the method comprising:
an input device;
an output device;
a processing unit operationally connected to the input device and the output device, the processing unit configured to execute instructions to perform:
displaying at least two roulette wheels;
displaying a playing field;
receiving a bonus wager from the player, the player selecting a particular number on the playing field that the bonus wager is associated with;
spinning the at least two roulette wheels; and
determining if the particular number is a result on two or more of the at least two roulette wheels, if not then the player loses the bonus wager, and if so, then awarding the player a payout on the bonus wager based on how many of the results match the particular number.
